(19) United States
(12) Patent Application Publication
(10) Pub. No.: US 2026/0276771 A1
(43) Pub. Date: Sep. 17, 2026

(54) Estimating Loudspeaker Elevation

(71) Applicant: Samsung Electronics Co., Ltd., Suwon-si (KR)

(72) Inventors: Sunil Bharitkar, Stevenson Ranch, CA (US); Adrian Celestinos Arroyo, Valencia, CA (US)

(21) Appl. No.: 19/554,328

(22) Filed: Mar. 2, 2026

Related U.S. Application Data
(60) Provisional application No. 63/770,225, filed on Mar. 11, 2025.

(51) Int. Cl. G01S 1/80; G01B 17/00; G01S 1/74; H04R 1/40

(52) U.S. Cl. CPC G01S 1/805; G01B 17/00; G01S 1/751; G01S 1/753; H04R 1/403; H04R 1/406

(57) ABSTRACT

In one embodiment, a method includes emitting, by each of multiple discrete loudspeakers, an excitation stimulus; and measuring, by each of multiple microphones, a response at that microphone due to the stimuli. Each of the discrete loudspeakers is proximal with at least one microphone in the set of microphones, and the microphones include at least two microphones separated by a predetermined distance. The method further includes determining, by deconvolving the microphone measurements, a set of loudspeaker room impulse responses; determining, from the set of loudspeaker room impulse responses, a distance between each discrete loudspeaker and each microphone; and estimating, based on the determined distances, an elevation angle of each of the discrete loudspeakers.

### PRIORITY CLAIM

This application claims the benefit under 35 U.S.C. § 119 of U.S. Provisional Patent Application No. 63/770,225 filed Mar. 11, 2025, which is incorporated by reference herein.

### TECHNICAL FIELD

This application generally relates to automatically estimating the elevation of loudspeakers.

### BACKGROUND

A loudspeaker converts an electrical audio signal into a corresponding sound. Loudspeakers can be used for playing music, listening to audio content corresponding to video content (e.g., audio of a TV show or a movie), etc. An entertainment system often involves multiple loudspeakers that play audio. For example, an entertainment system may include a pair of left-right stereo loudspeakers, a subwoofer loudspeaker, a center loudspeaker, a pair of left-right surround loudspeakers, and/or a pair of left-right rear surround loudspeakers. The number of loudspeakers in a system are often referred to by an x.y convention, where x is the number of loudspeakers used in the system and y refers to the number of subwoofers used in the system.

### BRIEF DESCRIPTION OF THE DRAWINGS

FIG. 1 illustrates an example method for detecting the elevation angles of loudspeakers.

FIG. 2 illustrates two examples of loudspeaker elevation estimations that use geometric estimators.

FIG. 3 illustrates an example computing system.

### DESCRIPTION OF EXAMPLE EMBODIMENTS

Calibrating loudspeakers in a room is important to deliver high-quality, immersive spatial audio for rendering immersive audio formats. Calibration involves computing and compensating for the time difference of arrival (TDOA) between loudspeaker signals, sound pressure level matching between loudspeakers, frequency equalization, and estimating the location of the loudspeakers for use with panning. To perform source localization, traditional signal processing methods such as GCC-PHAT and MUSIC form the basis for the signal processing models. Some deep-learning models have been used for source localization and tracking but have high computational and memory footprints, preventing use in real-time processing (e.g., in a digital signal processor).

The International Telecommunication Union (ITU), for example, has established a recommendation on the angular placement of the horizontal and elevation loudspeakers to obtain an immersive audio experience. The angles are relative to a listener at the listening location. For instance, for elevated loudspeakers in front of the listener and to the sides (e.g., speakers “Rtf” and “Ltf”) the ITU recommends that the elevation range be with 30-55°. Other angular-placement recommendations exist, as well.

However, in practice, loudspeakers are often placed outside of the recommended elevation ranges, both because people don't expend the time and effort to measure elevation ranges and mount loudspeakers accordingly, and because sometimes it is impractical to mount speakers at the recommended elevations given the physical layout of a listening space.

The techniques of this disclosure automatically estimate the actual elevation angles of loudspeakers. These actual elevations can then be used by, e.g., a renderer using crosstalk cancellation or vector panning, to process audio for playback on the loudspeakers so that the loudspeakers sound as if they are mounted within a particular elevation placement range (e.g., within the ITU's recommended placement range). As a result, loudspeakers that are placed outside the recommended elevation ranges can still sound as if they were within the recommended range, improving the listening experience for the user.

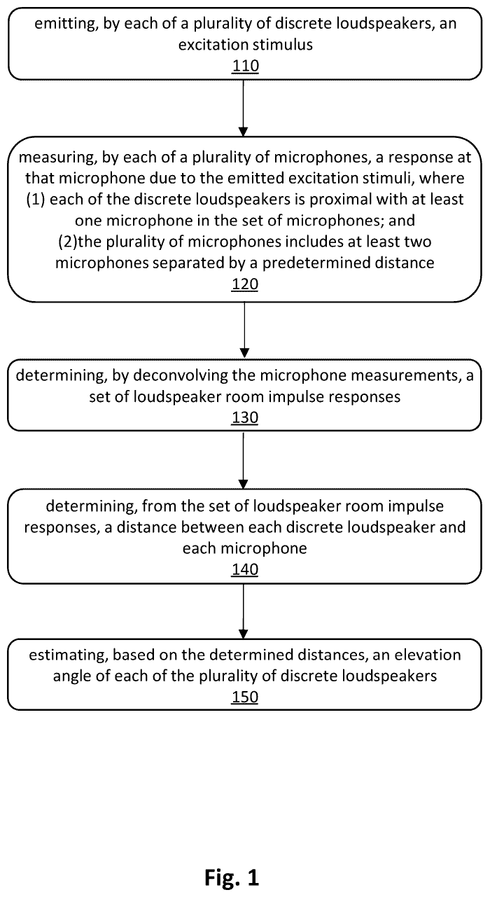

FIG. 1 illustrates an example method for detecting the elevation angles of loudspeakers. Step 110 of the example method of FIG. 1 includes emitting, by each of multiple, discrete loudspeakers, an excitation stimulus. For example, the excitation stimulus may be a log-sweep excitation signal, although other kinds of stimuli may be used. In the case of an exponential sweep, assuming that ω₁ and ω₂ are the start and end frequencies (in rad/s), with a total duration of T_{log} seconds, the logarithmic sweep signal x(t) is

$$x ( t ) = sin ( \frac{{ω}_{1} {T}_{log}}{log \frac{{ω}_{2}}{{ω}_{1}}} ( {e}^{\frac{t}{{T}_{log}} log ( \frac{{ω}_{2}}{{ω}_{1}} )} - 1 ) ) \qquad ( 1 )$$

where the discrete-time equivalent is x₁(n)=(x(n), x(n−1), x(n−2), . . . , x(n−(P_{log}−1)))^{T}, T represents the vector transpose and P_{log}=T_{log}fₛ in samples and fₛ is sampling frequency. In particular embodiments, the loudspeakers may simultaneously emit the excitation stimulus, such that each loudspeaker plays the stimulus at the same time. In other embodiments, some or each of the loudspeakers may play stimulus sequentially, although this approach takes longer to calibrate the system.

Step 120 of the example method of FIG. 1 includes measuring, by each of multiple microphones, a response at that microphone due to the emitted excitation stimuli. Each of the discrete loudspeakers includes a proximal microphone, such as a microphone in, on, or near each discrete loudspeaker. In addition, there are at least two microphones that are separated by a known distance adjacent to each other that serve as a reference. For example, the two microphones may be in a TV or a soundbar, and the loudspeakers may be speakers in x.y setup, may be speakers in another device such as a picture frame or a home assistant, etc. In particular embodiments, these two microphones may be relatively centrally located relative to the loudspeakers (e.g., the two microphones may be in a TV that is between Ltf and Rtf loudspeakers), although other configurations may be used. In particular embodiments, one or both microphones may be part of a component of the loudspeaker system (e.g., part of a soundbar on a TV that serves as the center channel).

Step 130 of the example method of FIG. 1 includes determining, by deconvolving the microphone measurements, a set of loudspeaker room impulse responses (IRs). The measurement of step 120 is a linear convolution sum between the ground-truth loudspeaker-room impulse response (IR) hᵢ and the stimuli xᵢ(n),

$$y ( n ) = {\sum }_{i = 1}^{N} {x}_{i} ( n ) \text{?} {h}_{i} \qquad ( 2 )$$

In embodiments in which each loudspeaker simultaneously emits the stimulus, then the N-channel log-sweep stimulus for simultaneous deconvolution is constructed by circularly shifting the log-sweep for each channel/loudspeaker stimulus relative to the stimulus xᵢ(n) applied to the first channel/loudspeaker. The duration P_{log} and circular shift value M are determined by minimizing the mean-square error between reconstructed room response and original (ground-truth) responses using a dataset of room responses.

$${x}_{i} ( n ) = {[ x ( n ) , x ( n - 1 ) , … , x ( n - {P}_{log} + 1 ) ]}^{T} ; \qquad ( 3 )$$

$${x}_{i} ( n ) = {[ x ( < n - ( i - 1 ) M {>}_{{P}_{log}} ) , … , x ( < n - ( i - 1 ) M - 1 {>}_{{P}_{log}} ) , … , x ( < n - ( i - 1 ) M - {P}_{log} + 1 ) {>}_{{P}_{log}} ]}^{T} ;$$

with i=(2, . . . , N), <m>_{P}_{_{log}}=m modulo P_{log}, and hᵢ=[h₁(1), hᵢ(2), . . . , hᵢ(K)]^{T} is a K-length impulse response. The loudspeaker-room responses are deconvolved using,

$${\hat{h}}_{j} = {ℱ}^{- 1} \{ \frac{{S}_{{x}_{j} , y} ( {e}^{j ω} )}{{S}_{{x}_{j} , {x}_{j}} ( {e}^{j ω} )} \} \qquad ( 4 )$$

where, Sₓ_{ⱼ}_{,y}(e^{jω}) and Sₓ_{ⱼ}_{,x}_{ⱼ}(e^{jω}) are cross- and auto-spectra, respectively. Multi-source simultaneous deconvolution has a significant measurement time advantage over single-channel-at-a-time measurement, as the former allows the estimation of impulse responses with all sources active at the same time during measurement. U.S. Pat. No. 11,792,594 describes simultaneous deconvolution techniques, and that description is incorporated by reference herein.

The process of FIG. 1 can occur more efficiently if simultaneous emission is used rather than sequential emission. For example, if (i) Tₘ is the total measurement time that includes stimulus duration for playback and the microphone recording time, (ii) Tₜ is the time it takes to switch between loudspeakers for single-channel measurements, and (iii) L_{avg} is the number of measurement averages for a high signal-to-noise ratio (SNR), then the single-channel-at-a-time approach takes τ_{conv}=NL_{avg}Tₘ+(N−1)Tₜ; whereas for simultaneous deconvolution it is τ_{SD}=L_{avg}Tₘ. With L_{avg}=3, Tₘ=5 s, Tₜ=3 (sec.), N=12 for an ITU 7.1.4, τ_{conv}=180 seconds whereas τ_{SD}=15 seconds.

Step 140 of the example method of FIG. 1 includes determining, from the set of loudspeaker room impulse responses, a distance between each discrete loudspeaker and each microphone. As described below, step 140 may include calculating the distance between some but not all speaker and microphone pairs, where such calculations are sufficient to fix the remaining, uncalculated distances. For example, the quadrilateral technique described below may calculate the distance between each loudspeaker and one of the two microphones having a known distance between them, and between each pair of loudspeakers. This calculation effectively fixes the distance between each loudspeaker and the other of the two microphones, although such distance need not be explicitly calculated. In essence, step 140 ensures that the distances between a loudspeaker-microphone pair is not indeterminate, and the specific distances that may be explicitly calculated may depend on the elevation technique used, as described below.

As an example of step 140, an onset detection technique for distance estimation comprises first normalizing the IR to unit amplitude and then applying a band-pass filter to isolate the higher-frequency components in the IR. A thresholding approach detects the time sample k, which is the first sample in which the absolute value of the IR exceeds a threshold, e.g., 0.1. The estimated distance \hat{d} can then be determined by \hat{d}=c*k/fₛ. Here, the speed of sound is c=343 and fₛ is the sampling frequency, e.g., 48 KHz.

Once step 140 is performed, then pairwise distances between devices can be used to localize the devices. To that end, step 150 of the example method of FIG. 1 includes estimating, based on the determined distances, an elevation angle of each of the plurality of discrete loudspeakers. As discussed herein, not every determined distance is necessarily used to determine every elevation angle; instead, step 150 includes embodiments in which a particular elevation angle for a particular loudspeaker is estimated based on some of the determined distances.

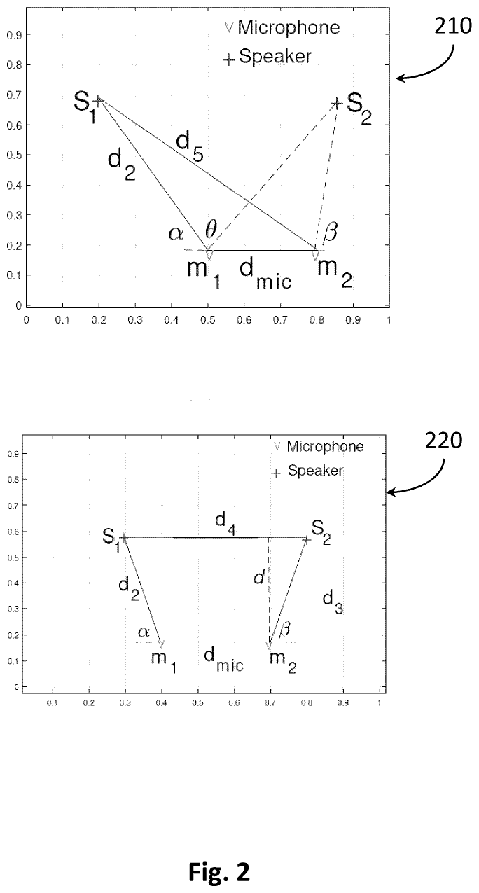

FIG. 2 illustrates two examples of step 150 that use geometric estimators. Estimator 210 is a triangle estimator, while estimator 220 is a quadrilateral estimator. For convenience, the example of FIG. 2 uses two loudspeakers, S₁ and S₂ and the two microphones m₁ and m_{2 str} separated by a known distance d_{mic}. The two loudspeakers are in about the same plane as the at least two microphones. This setup often occurs, for example, in a typical consumer home theater that involves two frontal discrete loudspeakers (e.g., left and right loudspeakers for stereo signals or the front loudspeakers of an ITU setup such as 5.1 or 7.1.4 system) mounted on each side but at arbitrary elevations relative to a microphone array in, e.g., a TV.

With reference to estimator 210 of FIG. 2, the angle α can be computed from the distances (d₂,d₃) and known inter-microphone spacing d_{mic}, as

$$θ = {cos}^{- 1} ( - \frac{{d}_{5}^{2} - ( {d}_{2}^{2} + {d}_{mic}^{2} )}{2 {d}_{2} {d}_{mic}} ) \qquad ( 5 )$$

with \hat{α}=π−θ. An important constraint for |cos(θ)|≤1 is d₅≤(d₂+d_{mic}); for the angles to be real and not imaginary.

With reference to estimator 220 of FIG. 2, the angles (\hat{α}, \hat{β}) can be determined using:

$$p = {d}_{2} + {d}_{3} + {d}_{4} - {d}_{mic} ; q = {d}_{2} + {d}_{3} + {d}_{mic} - {d}_{4} \qquad ( 6 )$$

$$r = {d}_{2} + {d}_{4} - {d}_{3} - {d}_{mic} ; s = {d}_{3} + {d}_{4} - {d}_{2} - {d}_{mic}$$

$$d = \sqrt{p \times q \times r \times s} / ( 4 {( {d}_{4} - {d}_{mic} )}^{2} )$$

$$\hat{α} = \frac{π}{2} - {sin}^{- 1} ( \sqrt{{d}_{2}^{2} - {d}^{2} ) / {d}_{2}^{2}} ;$$

$$\hat{β} = \frac{π}{2} - {sin}^{- 1} ( \sqrt{{d}_{3}^{2} - {d}^{2} ) / {d}_{3}^{2}} .$$

Particular embodiments may use a machine-learning model trained using supervised learning to perform step 150. For example, a generalized regression neural network (GRNN) can be used due to its “one-shot” training and its strong generalization ability. The GRNN is a form of radial basis function neural network whose approximation is based on linear combinations of nonlinear basis functions. Let Uᵢ=[uᵢ(1), uᵢ(2), . . . , uᵢ(m)]^{T} be an input vector and Vᵢ=[vᵢ(1), vᵢ(2), . . . , vᵢ(n)]^{T} be the output vector corresponding to the i-th training data (i=1, . . . , N). For an arbitrary input vector U=[u(1), u(2), . . . , u(m)]^{T}, the estimated output \hat{V} can be expressed as,

$$\underline{\hat{V}} = \frac{{\sum }_{i = 1}^{N} \frac{{\underline{V}}_{i}}{{σ}^{m}} exp ( - {‖ \underline{U} - {\underline{U}}_{1} ‖}^{2} / 2 {σ}^{2} )}{{\sum }_{i = 1}^{N} \frac{1}{{σ}^{m}} exp ( - {‖ \underline{U} - {\underline{U}}_{1} ‖}^{2} / 2 {σ}^{2} )} \qquad ( 7 )$$

In the example of FIG. 2, the input to the GRNN are distances (d₂, d₃, d₄, d_{mic}). The output is the two estimated angles (\hat{α}, \hat{β}) from equation 6, above.

As another example, particular embodiments may use a Kolmogorov-Arnold Networks (KANs) as an alternative to feedforward multilayer networks (MLP) leveraging the Kolmogorov-Arnold Theorem. The KAN is a two-layer neural network with activation functions on the edges rather than the nodes. KAN's key feature is the replacement of traditional weights with learnable activation functions. In the example of FIG. 2, the inputs to the KAN are distances (d₂, d₃, d₄, d_{mic}), and the output is the two angles (\hat{α}, \hat{β}) from equation 6, above.

Particular embodiments may use a machine-learning model that uses unsupervised learning to perform step 150. For example, Multidimensional scaling (MDS) is a technique that maps distance data between pairs of objects into distances between points in a multidimensional space (usually two or three dimensions). The final visual representation includes coordinates of objects that satisfy the distance relationships between the objects. Particular embodiments may use as input to the MDS (d₂, d₃, d₄, d_{mic}, d_{S}_{₁}_{,m}_{₂}, d_{S}_{₂}_{,m}_{₁}), referring to the example of FIG. 2. The elevation angles can be determined once the coordinates are determined using MDS relative to two microphones (m₁ and m₂ in the example of FIG. 2).

Other approaches may be used, including GCC-Nonlin and MUSIC, described below. However, neither of these techniques can cope with multiple active loudspeakers at the same time, but the methods can still be used with each of the at least two microphone-captured signal yᵢ(n)=xⱼ(n)\textcircled{*}h_{j,i}(n); (i=1,2). For example, the generalized cross-correlation with phase transform (GCC-PHAT) method is an angular spectrum-based method for DOA estimation. Based on the assumption that the direct sound of one source predominates in each time-frequency bin, the TDOA \hat{τ} is estimated from the phase difference between a pair of microphone-captured signals. With R_{x1,x2}(t, f) being the time-frequency based covariance matrix, the GCC-PHAT solution is,

$${∅}_{GCC} ( t , f , τ ) = ℜ \{ \frac{{R}_{{y}_{1} , {y}_{2}} ( t , f ) {e}^{- 2 π f τ}}{\vert {R}_{{y}_{1} , {y}_{2}} ( t , f ) \vert} \} \qquad ( 8 )$$

with \hat{τ}=argmax_{τ}(Ø_{GCC}(t, f, τ)) and R{⋅} denoting the real part. The angle of the loudspeaker using far-field assumptions is \hat{θ}=cos⁻¹(d_{mic}/c\hat{τ}) with d_{mic}<<dᵢ; ∀i.

As another example, multiple signal classification (MUSIC) and variants is a subspace-based method that incorporates eigenvalue decomposition of a sample covariance matrix to project signals into a subspace while filtering out unwanted noise. The DOA is then computed by analyzing the MUSIC pseudo-spectra over a grid for peaks associated with candidate angles described by the projection of a steering vector α(θ) on the noise subspace Eₙ comprised of the eigenvectors of M−D lowest eigenvalues of the covariance matrix for D sources

$${P}_{MUSIC} ( θ ) = 1 / ( {a}^{H} ( θ ) {E}_{n} {E}_{n}^{H} a ( θ ) ) . \qquad ( 9 )$$

The training set for a supervised machine-learning model, such as the GRNN, can be derived using real or synthetic positions/distances (as input) and angles (computed using positions relative to the two microphones separated by a known distance). For example, a synthetic-data approach can use rectangular coordinates to derive distances between speakers and microphones, so as to train and test the various models. The speaker acoustical centers may be used to measure ground-truth physical distances, or the physical center of the speaker may be used for simplicity due to differences in acoustical centers for different loudspeakers (e.g., some speakers are front-firing while others are side-firing).

As one example, synthetic data generation may include creating a random distribution such as N₁=1000 datapoints for the locations of loudspeakers on each side of the two microphones separated by a known distance. The ground-truth distances and synthetic elevation angles between speakers and microphones, (α,β)^{T}, corresponding to angles shown in FIG. 2 are computed with trigonometry. A training input matrix R^{1000×4} may be used for the GRNN (with σ=0.08) and KAN using the four input distances, whereas for an MDS model, all six distances may be used as input. In the case of GCC-Nonlin and MUSIC, the signals at each of the TV microphones, yᵢ, are generated by convolving a male speech signal xⱼ(n) located at source Sⱼ with h_{j,i}(n)=δ(n−[dᵢfₛ/c])³.

The example of FIG. 1 may be used to calibrate a particular system after setup. For example, a user may place each loudspeaker in its desired location and then execute the method of FIG. 1 (e.g., using a UI on a device such as a smartphone, TV, etc.) to have the system automatically estimate elevation angles of the loudspeakers in the system. In other embodiments, the system may automatically execute this functionality. This calibration may be repeated, e.g., periodically or on user demand (e.g., if the user alters the system by adding, removing, or moving loudspeakers).

As described above, once actual elevation angles are estimated, then a renderer (e.g., of a digital signal processor) may use the estimated actual elevation angles (whether in Cartesian coordinates, polar coordinates, or another coordinate system) to process sound for one or more of the loudspeakers so that the sound from that loudspeaker sounds as if it is in fact located at a recommended elevation angle (e.g., at an elevation angle corresponding to an ITU recommendation for that speaker's role in the sound system). For example, the estimated elevations in step 150 may be relative to one of the two microphones separated by a known distance. The system may further estimate elevation angles relative to a listening position, e.g., given that the microphones may be in a TV and the listening position is about 3 meters or so from the TV, and then a renderer may use the inferred elevation angles to adjust the sound. In other approaches a render may use the estimated angles directly to adjust the sound content.

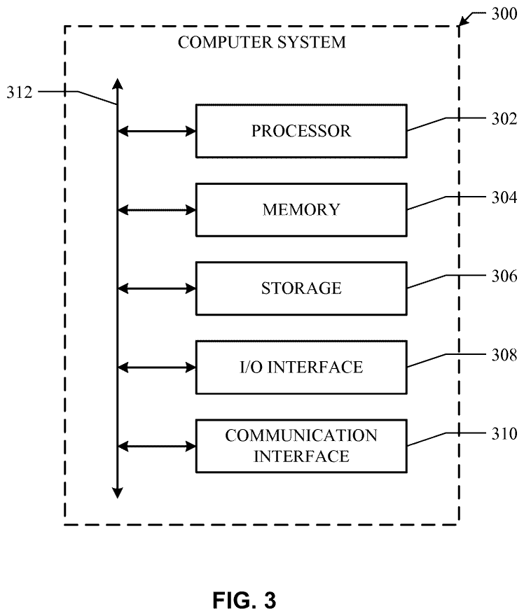

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
emitting, by each of a plurality of discrete loudspeakers, an excitation stimulus;
measuring, by each of a plurality of microphones, a response at that microphone due to the emitted excitation stimuli, wherein:
each of the discrete loudspeakers is proximal with at least one microphone in the set of microphones; and
the plurality of microphones includes at least two microphones separated by a predetermined distance;
determining, by deconvolving the microphone measurements, a set of loudspeaker room impulse responses;
determining, from the set of loudspeaker room impulse responses, a distance between each discrete loudspeaker and each microphone; and
estimating, based on the determined distances, an elevation angle of each of the plurality of discrete loudspeakers.

2. The method of claim 1, wherein (1) each of the plurality of discrete loudspeakers simultaneously emits the excitation stimulus and (2) deconvolving the microphone measurements comprises applying simultaneous deconvolution.

3. The method of claim 1, wherein each of the plurality of discrete loudspeakers is substantially in the same plane as the at least two microphones.

4. The method of claim 3, wherein estimating, based on the determined distances, the elevation angle of each of the plurality of discrete loudspeakers comprises estimating each elevation angle based on a geometric estimator comprising at least one of (1) a triangle estimator or (2) a quadrilateral estimator.

5. The method of claim 1, wherein estimating, based on the determined distances, the elevation angle of each of the plurality of discrete loudspeakers comprises estimating each elevation angle based on a supervised machine-learning model.

6. The method of claim 5, wherein each of the plurality of discrete loudspeakers is in the same plane as the at least two microphones.

7. The method of claim 1, wherein estimating, based on the determined distances, the elevation angle of each of the plurality of discrete loudspeakers comprises estimating each elevation angle based on an unsupervised machine-learning model.

8. The method of claim 7, wherein each of the plurality of discrete loudspeakers is in the same plane as the at least two microphones.

9. The method of claim 1, further comprising adjusting, by a renderer, audio for playback by at least one of the plurality of discrete loudspeakers based on that loudspeaker's estimated elevation angle.

10. A system comprising:
one or more non-transitory computer readable storage media storing instructions, and one or more processors coupled to the one or more non-transitory computer readable storage media and operable to execute the instructions to:
instruct each of a plurality of discrete loudspeakers to emit an excitation stimulus;
instruct each of a plurality of microphones to measure a response at that microphone due to the emitted excitation stimuli, wherein:
each of the discrete loudspeakers is co-located with at least one microphone in the set of microphones; and
the plurality of microphones includes at least two microphones separated by a predetermined distance;
determine, by deconvolving the microphone measurements, a set of loudspeaker room impulse responses;
determine, from the set of loudspeaker room impulse responses, a distance between each discrete loudspeaker and each microphone; and
estimate, based on the determined distances, an elevation angle of each of the plurality of discrete loudspeakers.

11. The system of claim 10, wherein (1) each of the plurality of discrete loudspeakers simultaneously emits the excitation stimulus and (2) deconvolving the microphone measurements comprises applying simultaneous deconvolution.

12. The system of claim 10, wherein each of the plurality of discrete loudspeakers is in substantially the same plane as the at least two microphones.

13. The system of claim 12, wherein estimating, based on the determined distances, the elevation angle of each of the plurality of discrete loudspeakers comprises estimating each elevation angle based on a geometric estimator comprising at least one of (1) a triangle estimator or (2) a quadrilateral estimator.

14. The system of claim 10, wherein estimating, based on the determined distances, the elevation angle of each of the plurality of discrete loudspeakers comprises estimating each elevation angle based on a supervised machine-learning model.

15. The system of claim 14, wherein each of the plurality of discrete loudspeakers is in the same plane as the at least two microphones.

16. The system of claim 10, wherein estimating, based on the determined distances, the elevation angle of each of the plurality of discrete loudspeakers comprises estimating each elevation angle based on an unsupervised machine-learning model.

17. The system of claim 16, wherein each of the plurality of discrete loudspeakers is in the same plane as the at least two microphones.

18. The system of claim 10, further comprising one or more processors that are operable to execute the instructions to adjust audio for playback by at least one of the plurality of discrete loudspeakers based on that loudspeaker's estimated elevation angle.

19. One or more non-transitory computer-readable storage media comprising instructions that are operable when executed by one or more processors to:
instruct each of a plurality of discrete loudspeakers to emit an excitation stimulus;
instruct each of a plurality of microphones to measure a response at that microphone due to the emitted excitation stimuli, wherein:
each of the discrete loudspeakers is co-located with at least one microphone in the set of microphones; and
the plurality of microphones includes at least two microphones separated by a predetermined distance;
determine, by deconvolving the microphone measurements, a set of loudspeaker room impulse responses;
determine, from the set of loudspeaker room impulse responses, a distance between each discrete loudspeaker and each microphone; and
estimate, based on the determined distances, an elevation angle of each of the plurality of discrete loudspeakers.

20. The media of claim 19, wherein each of the plurality of discrete loudspeakers is in substantially the same plane as the at least two microphones.
